(19) United States
(12) Patent Application Publication
(10) Pub. No.: US 2024/0277565 A1
(43) Pub. Date: Aug. 22, 2024

(54) MASSAGING DEVICE

(71) Applicant: Land Business Co., Ltd., Tokyo (JP)

(72) Inventor: Masamichi KAMEI, Tokyo (JP)

(21) Appl. No.: 18/567,444

(22) PCT Filed: Jun. 14, 2022
(86) PCT No.: PCT/JP2022/023730

§ 371 Date: Dec. 6, 2023

(30) Foreign Application Priority Data
Jun. 23, 2021 (JP) 2021-103745

(51) Int. Cl. A61H 23/02; A61H 7/00

(52) U.S. Cl. CPC A61H 23/02; A61H 7/005; A61H 2201/0153; A61H 2201/1207; A61H 2201/169

(57) ABSTRACT

A massaging device according to the present application includes: a plurality of brush-like stimulation units 3 attached to a lower surface of a body unit 2, the stimulation units 3 each having a plurality of protrusions 3a; and a drive means provided inside the body unit 2 for vibrating or oscillating the stimulation units 3. By activating the drive means and pressing the protrusions 3a of the stimulation units 3 against the surface of skin, it is made possible to apply stimulation to the skin and an area under the skin in a pressed state, providing a massaging effect. In such configuration, the tip ends of the stimulation units 3 are covered with a sheet-like protective film 4 including a plurality of layers of films 4a, 4b that are slidable on each other in an in-plane direction. Because the tip ends of the stimulation units 3 are covered with the protective film 4, it is made possible to prevent the hair from getting entangled around the protrusions 3a of the stimulation units 3 when used for scalp stimulation, for instance, and to prevent the protrusions 3a from causing damages on the skin when excessive force is applied to the stimulation units 3.

### TECHNICAL FIELD

This invention relates to a massaging device of a type that applies stimulation to the skin by a plurality of brush-like protrusions.

### BACKGROUND ARTS

Conventionally, it is known that a massage performed by the fingertips for the skin such as the scalp, the face, the arm and others is effective in making a blood circulation better, and consequently, various types of massage brushes and massaging devices, such as a massage brush that applies stimulation to the skin by a plurality of brush-like protrusions and a massaging device that incorporates a drive mechanism to vibrate or oscillate protrusions, have been developed and are being made commercially available.

For instance, as one massage brush capable of acquiring a sufficient massage effect by means of pressing, strong rubbing, kneading, light rubbing or hammering etc., a patent document 1 below discloses a massage brush having a base, a plurality of pressing protrusions protruding downwards from an inside surface of the base, and a grip part connected to a central portion of an outside surface of the base, wherein the base is provided with a plurality of circumferentially spaced tongue pieces extending outwards from the central portion in a state in which the tongue pieces are protruding in a cantilever form due to the arrangement of a through groove around the base except a basal end on a central portion side, and the pressing protrusions are respectively provided in a state of being protruding downwards from tip end portions of the tongue pieces.

As one massaging tool capable of promoting the hair growth for the hair by mainly massaging the scalp in a grabbing massage manner to make a blood circulation better, while being usable also as a brush when used for washing the hair, a patent document 2 below discloses a massaging tool having a board-shaped massaging tool body configured such that a massaging part being an abutting-side surface to be applied to the head and a pressing part being a pressing-side surface on the side opposite to the abutting-side surface are positioned on the front and back sides of the massaging tool body, wherein the massaging part of the massaging tool body is provided with an array of massaging leg parts that are subjected to tilting and falling-down movement toward the center of the massaging tool body by a pressing action from the pressing part toward the head, thereby realizing a massage of the scalp in the grabbing massage manner by the tilting and falling-down movement of the massaging leg parts.

As one massaging device that performs massaging operation so as to massage the scalp etc., a patent document 3 below discloses a massaging device having a drive unit and a treatment unit driven by the drive unit, wherein the treatment unit is constituted of a base made of a material having flexibility and a plurality of protrusions provided on a surface of the base so as to be protruding therefrom, and the drive unit is provided with a frame body that holds detachably the peripheral edge of the base in a state in which a positional relationship with respect to the drive unit is fixed, the drive unit being also provided with a reciprocating drive means that deflects the base in a direction intersecting the surface of the base.

Non-patent document 1 below describes a massaging device that applies stimulation to the scalp in a manner in which a plurality of brush-like protrusions dispersedly arranged on a lower surface of a body unit are operated so as to lift up the scalp, while being subjected to three-dimensional movement at the same time as tilting movement through a roller part.

### PRIOR ART DOCUMENTS

### Patent Documents

Patent document 1: Japanese Unexamined Patent Application Publication No. 2011-083593
Patent document 2: Japanese Unexamined Patent Application Publication No. 2019-141194
Patent document 3: Japanese Unexamined Patent Application Publication No. 2009-165664
Patent document 4: Japanese Unexamined Patent Application Publication No. 2004-121327
Patent document 5: Japanese Unexamined Patent Application Publication No. 2014-171856
Patent document 6: Japanese Unexamined Patent Application Publication No. 2000-126262
Patent document 7: Japanese Utility Model (Registration) Publication No. 3174864
Patent document 8: Microfilm of Japanese Utility Model (Registration) Application No. Sho 52-83435 (Japanese Unexamined Utility Model (Registration) Application Publication No. Sho 54-11097)

### Non-Patent Document

Non-patent document 1: ReFa official brand site, ReFa GRACE HEAD SPA [online], MTG Corporation, [Retrieval on Jun. 23, 2021], Internet URL: http://www.refa.net/item/refa_grace_head_spa/

### SUMMARY OF THE INVENTION

### Problems to be Solved by the Invention

The massage brush as disclosed in the patent document 1 and the massaging tool as disclosed in the patent document 2 are to be used with a hand in the same manner as a general type of brush, without being provided with any drive mechanism. Accordingly, although it may be possible to expect an effect on improvement of a blood circulation and other massage effects, such massage brush and massaging device need manual massaging operation and are thus assumed to be not for every user.

The massaging device as disclosed in the patent document 3 and the massaging device as described in the non-patent document 1 are a massaging device of a type in which the brush-like protrusions are driven by a rechargeable battery etc., for instance, to apply efficient stimulation to the scalp and other skin, and hence, it may be possible to expect a high massage effect, and also to prevent a user from feeling fatigue of one's hand thanks to the massaging device of a drive type. However, if excessive force is applied and/or use for a long time more than needed takes place, the protrusions may cause damages on the skin. Besides, there is also the possibility that the protrusions may cause the hair to get entangled therearound during use in an incorrect way, and/or that the user may accidentally cause the edge of one's worn clothes to get caught in the protrusions.

An object of the present invention is to provide, in relation to a massaging device of a type in which brush-like stimulation units provided on a lower surface of a body unit are driven by a drive means, a high-safety massaging device having no possibility that the brush-like stimulation units may cause damages on the skin when excessive force is applied and/or that the hair may get entangled around the brush-like stimulation units.

### Means for Solving the Problems

A massaging device according to the present invention comprises a body unit; a plurality of brush-like stimulation units attached to a lower surface of the body unit, the stimulation units each having a plurality of dispersedly arranged protrusions; and a drive means for vibrating or oscillating the stimulation units with respect to the body unit, wherein the tip ends of the stimulation units are covered with a sheet-like protective film, and the protective film is constituted of a plurality of layers of films that are slidable on each other in an in-plane direction, the plurality of layers of films being made of a low-frictional material or being each configured so as to have a surface having been subjected to low-frictional surface treatment.

As a way of using this massaging device, the drive means is activated by the on-operation of a switch, for instance, and then, the plurality of dispersedly arranged protrusions of the stimulation units are pressed against the surface of skin such as the scalp, the face and the arm. By so doing, it is made possible to apply stimulation to the skin and an area under the skin in a pressed state, thus providing a massaging effect.

For a drive source of the drive means, use may be made of a battery etc., for instance. Further, a system for driving the stimulation units is not particularly limited, and hence, it may be possible also to incorporate a driving system similar to that of each existing massaging device set forth in the preceding column of BACKGROUND ARTS, for instance.

In the massaging device of the present invention, the tip ends of the stimulation units each having the plurality of dispersedly arranged protrusions are covered with the sheet-like protective film, and accordingly, it is made possible to prevent the hair from getting entangled around the protrusions of the stimulation units when used for scalp stimulation, for instance, and to prevent the protrusions from causing damages on the skin when excessive force is applied to the stimulation units.

Further, even when used for stimulation to some body part other than the head, it is made possible also to prevent the user from accidentally causing one's worn clothes to get caught in the protrusions of the stimulation units.

It is desirable that the sheet-like protective film shall be as thin as possible to prevent movement of the protrusions of the stimulation units from being impeded, and also shall be made deformable in response to the movement of the protrusions of the stimulation units. For the protective film, use may be made of a polyethylene, polypropylene, polyester, nylon, fluorine resin or like resin sheet or resin film etc., for instance.

Further, such configuration that the protective film is constituted of the plurality of layers of films that are slidable on each other in the in-plane direction makes it possible to further enhance an effect of preventing the movement of the protrusions of the stimulation units from being impeded during the use of the massaging device.

The protective film may be formed so as to all-inclusively cover the whole of the stimulation units each having the plurality of dispersedly arranged protrusions, or alternatively, as determined by the form of each stimulation unit having the plurality of brush-like protrusions in the massaging device, it may be possible also to form the protective film so as to cover the stimulation units with the protective film unit by unit.

As based on the form of the massaging device, there is also a massaging device of a type that is used such as to hold the entire device by the user with one's hand as it is, or alternatively, it may be possible also to form the body unit of the massaging device so as to have a grip part, thereby allowing the user to use the massaging device while holding the grip part with one's hand.

### Effects of the Invention

In the massaging device of the present invention, the tip ends of the stimulation units each having the plurality of dispersedly arranged protrusions are covered with the sheet-like protective film constituted of the plurality of layers of films, and accordingly, when used for applying stimulation to the scalp and other skin, for instance, it is made possible to prevent the protrusions from causing damages on the skin when excessive force is applied to the stimulation units, and to prevent the hair from getting entangled around the protrusions of the stimulation units.

Further, even when used for stimulation to some body part other than the head, it is made possible also to prevent the user from accidentally causing one's worn cloths to get caught in the protrusions of the stimulation units.

### BRIEF DESCRIPTION OF THE DRAWINGS

FIG. 1 is a front view showing one embodiment of a massaging device of the present invention, together with a sectional view showing only a protective film part.

FIG. 2 is a conceptional view showing a usage status of the massaging device of the present invention.

FIG. 3 is a front view showing a massaging device as one comparative example.

FIG. 4 is a conceptional view showing a usage status of the massaging device shown as one comparative example in FIG. 3.

### MODE FOR EMBODYING THE INVENTION

Hereinafter will be described the present invention with reference to the attached drawings.

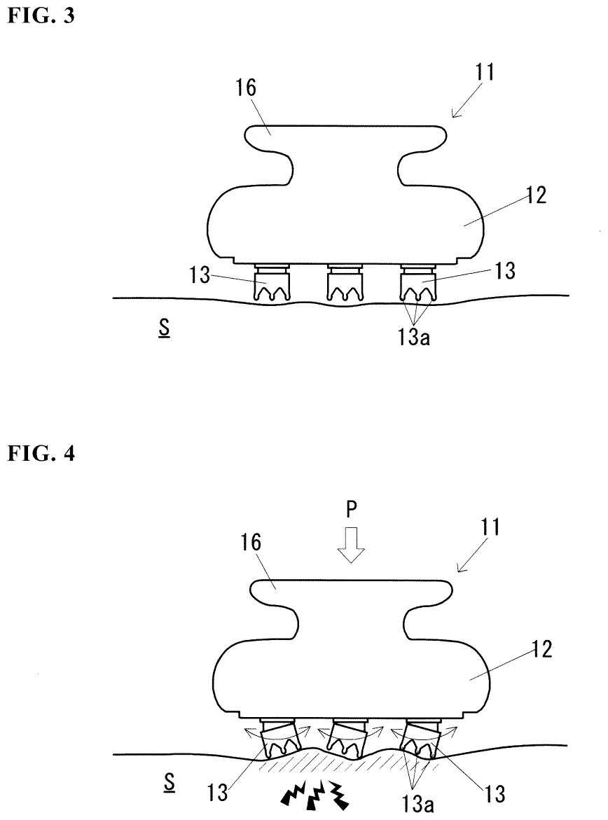

FIG. 3 is a front view showing a massaging device of a drive type as one comparative example, and FIG. 4 is a conceptional view showing a usage status of the massaging device shown in FIG. 3.

A massaging device 11 shown in FIG. 3 is configured such that a plurality of brush-like stimulating unit 13 each having a plurality of protrusions 13a are attached to a lower surface of a body unit 12, and that a drive means (not shown) for vibrating or oscillating the stimulation units 13 is provided inside the body unit 12.

As a way of using this massaging device, the drive means is activated by the on-operation of a switch, for instance, and then, the protrusions 13a of the stimulation units 13 are pressed against the surface of skin such as the scalp, the face and the arm. By so doing, it is made possible to apply stimulation to the skin and an area under the skin in a pressed state, thereby providing a massaging effect.

However, as set forth in the preceding column of PROBLEMS TO BE SOLVED BY THE INVENTION, the conventional drive-type massaging device of this kind has the possibility that the protrusions may cause damages on the skin when excessive force is applied to the stimulation units and/or that the hair may get entangled around the protrusions 13a.

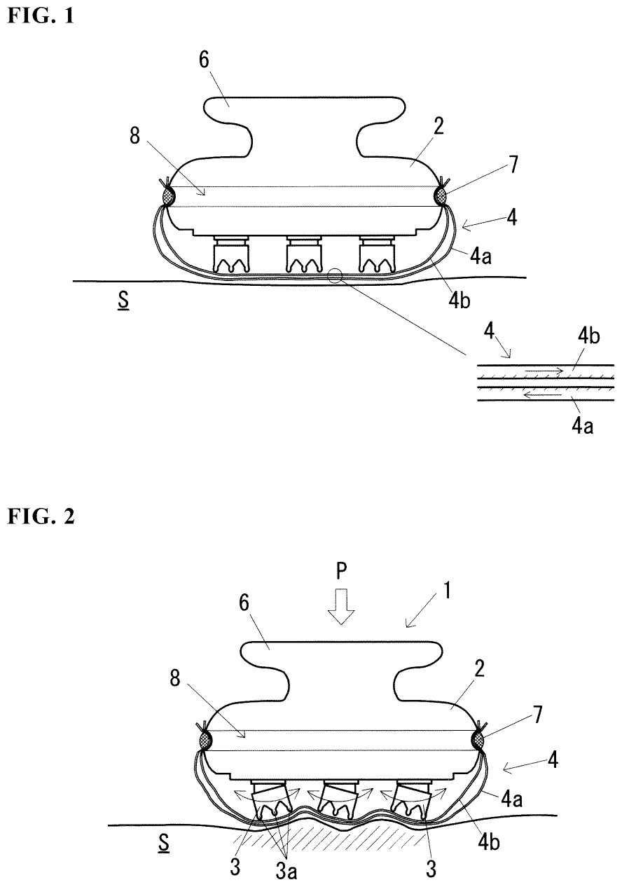

In contrast, FIG. 1 is a front view showing one embodiment of a massaging device of the present invention, together with a sectional view showing only a protective film part, and FIG. 2 is a view showing a usage status of this massaging device.

A massaging device 1 comprises a body unit 2, a plurality of brush-like stimulation units 3 attached to a lower surface of the body unit 2, the stimulation units each having a plurality of dispersedly arranged protrusions 3a, and a drive means (not shown) for vibrating or oscillating the stimulation units 3 with respect to the body unit 2, wherein the body unit 2 and the stimulation units 3 are the same in basic form as those of the above comparative example.

In regard to the above configuration, the massaging device 1 of the present invention is further configured such that the tip ends of the stimulation units 3 are covered with a sheet-like protective film 4. Such configuration that the tip ends of the stimulation units 3 are covered with the protective film 4 makes it possible to prevent the protrusions 3a from causing damages on the skin when excessive force is applied to the stimulation units 3 and to prevent the hair from getting entangled around the protrusions 3a of the stimulation units 3.

As a way of using this massaging device, the drive means is activated by the on-operation of a switch, for instance, and then, the plurality of dispersedly arranged protrusions 3a of the stimulation units 3 are pressed against the surface of skin such as the scalp, the face and the arm. By so doing, it is made possible to apply stimulation to the skin and an area under the skin, with the protective film 4 interposed between the stimulation units and the skin, thereby providing a massaging effect.

Further, even when used for stimulation to some body part other than the head, it is made possible also to prevent the user from accidentally causing one's worn clothes to get caught in the protrusions of the stimulation units.

It is desirable that the sheet-like protective film 4 shall be as thin as possible to prevent movement of the protrusions 3a of the stimulation units 3 from being impeded, and also shall be made deformable in response to the movement of the protrusions 3a of the stimulation units 3. For the protective film, use may be made of a polyethylene, polypropylene, polyester, nylon, fluorine resin or like resin film or resin sheet etc., for instance.

The protective film 4 is constituted of a plurality of layers of films 4a, 4b that are slidable on each other in an in-plane direction, wherein a low-frictional material may be used for the films 4a, 4b, or alternatively, it may be possible also to configure the films 4a, 4b so as to each have a surface having been subjected to low-frictional surface treatment using a fluorine-based coating agent etc., for instance.

As shown in FIGS. 1 and 2, when the sheet-like protective film 4 is formed such as to cover the whole of the plurality of brush-like stimulation units 3, it may be possible also to fasten the protective film 4 to an outer periphery of the body unit 2 of the massaging device 1 with fasteners 7. Available materials for the fasteners 7 may include rubber or like elastic material and metal or like spring material. In this case, it may be possible also to preliminarily form a groove part 8 in the body unit 2 so as to fasten the protective film to the groove part 8 with the fasteners 7.

Although a drive source of the drive means for vibrating or oscillating (i.e., either one or both of vibrating and oscillating operations for) the stimulation units 3 is not particularly limited, use may be made of a rechargeable battery etc., for instance.

### EXPLANATION OF REFERENCE NUMERALS

1 . . . Massaging device; 2 . . . Body unit; 3 . . . Stimulation unit; 3a . . . Protrusion; 4 . . . Protective film; 6 . . . Grip part; 7 . . . Fastener; 8 . . . Groove part; S . . . Skin

1. A massaging device comprising a body unit, a plurality of brush-like stimulation units attached to a lower surface of said body unit, said stimulation units each having a plurality of dispersedly arranged protrusions, and a drive means for vibrating or oscillating said stimulation units with respect to said body unit, wherein the tip ends of said stimulation units are covered with a sheet-like protective film, and said protective film is constituted of a plurality of layers of films that are slidable on each other in an in-plane direction, said plurality of layers of films being made of a low-frictional material or being each configured so as to have a surface having been subjected to low-frictional surface treatment.

2. The massaging device according to claim 1, wherein said massaging device includes a massaging device intended to apply stimulation to the scalp by said stimulation units.

3. The massaging device according to claim 1, wherein said protective film covers the whole of said stimulation units each having said plurality of dispersedly arranged protrusions.

4. The massaging device according to claim 1, wherein said body unit is provided with a grip part intended to allow a user to hold the body unit with one's hand.
